(19) United States
(12) Patent Application Publication
(10) Pub. No.: US 2010/0255177 A1
(43) Pub. Date: Oct. 7, 2010

(54) Natural Blue Falvorants and Colorants

(76) Inventor: Richard Rice, Tehachapi, CA (US)

Correspondence Address: BOND, SCHOENECK & KING, PLLC, ONE LINCOLN CENTER, SYRACUSE, NY, 13202-1355, US

(21) Appl. No.: 12/753,278

(22) Filed: Apr. 2, 2010

Related U.S. Application Data
(60) Provisional application No. 61/166,250, filed on Apr. 3, 2009.

(51) Int. Cl. A23L 1/28

(52) U.S. Cl. 426/655; 426/431; 426/429

(57) ABSTRACT

A natural blue flavorant and/or solution that is stable at pH 3.0 up to 7.0 is produced by extracting plant materials with organic solvents and or water with the addition of aluminum and or stannous salts. The solvents are removed thus allowing the flavorant to provide a blue hue when incorporated into products within the 3.0 to 7.0 pH range. The natural blue flavorant can be used in combination with natural yellow flavorants to produce natural green flavorants of various shades.

### CROSS-REFERENCE TO RELATED APPLICATIONS

The present application claims priority to U.S. Provisional Application No. 61/166,250, filed on Apr. 3, 2009.

### BACKGROUND OF THE INVENTION

1. Field of the Invention

The present invention relates to the creation of natural blue and natural green flavorants and/or colorants and, more specifically, the invention of natural blue and green compounds that are stable at a pH above and more uniquely below 4.0. The stabilities of these natural blue and green compounds at relatively low pH allow for their applicability in high acid foods and beverages as defined by the Food & Drug Administration (FDA). These natural blue and green compounds also show shelf lives sufficient for use in drug and cosmetic applications.

2. Description of the Related Art

Artificial colors are also known as certifiable colors because they are required to undergo certification by the Food and Drug Administration (FDA) prior to usage in food or drugs. Artificial colors currently provide a wide array of colors for use in foods, beverages, drugs and cosmetics. However, consumers are demanding natural colorant and flavorant alternatives.

Many sources of colors used to manufacture natural colorants and flavorant contain anthocyanins. Anthocyanins are water soluble pigments that occur in numerous plants, vegetables and flowers. Anthocyanins exhibit unique qualities at varying levels of pH. In acidic environments whereby the pH would be approximately 3, the anthocyanins most often exhibit a red color, however when exposed to a more basic environment for example pH 7 the anthocyanin will often display a blue or green hue. Anthocyanins rarely, if ever are perceived to be blue in color when part of a matrix where the pH would be relatively low.

Extracts of violas and pansies contain various forms of a particular species of anthocyanins known as delphinidins as well as other species and compounds. Delphinidins are partially responsible for the blue color of blue and purple pansies as well as the blue hues often noticed in blueberries, purple carrots and egg plant peels. Delphinidins are also susceptible to hue changes at a low pH.

As a result of the susceptibility of blue and green colorants and flavorants to low pH, such colorants and flavorant are noticeably missing from the natural colorant and flavorant category and could be used in a wide variety of food, drug and cosmetic applications.

### BRIEF SUMMARY OF THE INVENTION

It is therefore a principal object and advantage of the present invention to produce stable blue and green natural colorants and flavorants that retain their hue when used as a colorant or flavorant in highly acidic and neutral environments.

It is another object and advantage of the invention to provide blue and green natural colorants and flavorants by the removal of interfering compounds by fractionation and by stabilization via coumaric acid found naturally in the leaves and stems of certain plant sources as listed.

In accordance with the foregoing objects and advantages, the present invention provides stabilized blue and green colorants and flavorants, hereinafter referred to as just flavorants or colorants, which provide a natural colorant alternative to artificial colors currently utilized in both the high and low acid food categories. In one aspect of the invention, a blue flavorant comprises two main ingredients: pansy extract and stannous chloride. The combination of these two ingredients produces a blue flavorant that is stable in the pH range of 3.0 to 7.0. In a preferred embodiment of the present invention, the flavorant is produced utilizing solvents such as water and or alcohols as an extractive and stannous chloride in the finished color.

### BRIEF DESCRIPTION OF THE SEVERAL VIEWS OF THE DRAWING(S)

The present invention will be more fully understood and appreciated by reading the following Detailed Description in conjunction with the accompanying drawings, in which:

FIG. 1 is a flowchart of a method of producing a flavorant according to the present invention.

### DETAILED DESCRIPTION OF THE INVENTION

All references to percentages herein are to percentages by weight unless otherwise indicated. The stabilized blue colorant and/or flavorant of the present invention is formed by the combination of two main ingredients, namely, extract of viola (preferably viola odoraa l) and stannous chloride. As discussed below, additional ingredients and compounds may be added to the flavorant solution depending upon the application. Although aluminum chloride may be substitute for stannous chloride, stannous is chloride is preferred due to its recognized safety for human consumption.

The present invention comprises either an aqueous or dried mixture of a viola or pansy extract and a metallic salt, such as stannous chloride. In a preferred embodiment, the invention comprises a viola extract of between three and fifteen parts water to one part plant material and about 16 ppm to 1600 ppm stannous chloride per liter of extract. The amount of extractant needed or preferred varies in direct relationship to the color density of the plant material, i.e., deeply colored flowers will require more extractant and lighted colored flowers will require less. It should be recognized by those of skill in the art that the permeate or retentate of the present invention could be concentrated, dried, or diluted while maintaining the preferred ratio of compounds. For example, the preferred embodiment of the invention comprises 160 ppm of stannous chloride per liter of extract at a water content level of ninety-five percent. While the water percentage may be reduced to concentrate the flavorant, the relative ratio of extracted plant material to stannous chloride would remain constant for any water level, including a nearly water-free dried mixture. Thus, the present invention could be made and sold as a powder or concentrated liquid to be reconstituted or diluted for use in a product sold to an end user.

The method of the present invention may comprise extracting, either singly or in combination, violas and pansies with an acetate, such as ethyl acetate, at concentrations from 0% up to 100%, followed by an alcohol, such as ethyl alcohol, at concentrations from 0% up to 100%, followed by acidified water with the addition of aluminum and/or stannous salts followed ultimately by the removal of the organic solvents from the solution by conventional methods. Viola is preferred due to its status as Generally Recognized as Safe (GRAS) although other members of the violaceae family may suffice. Viola may also be used, either singly or in combination with eggplant, blueberry, purple carrots, and pansies. The pH range of the resulting solution may range from about 3.0 up to about 7.0.

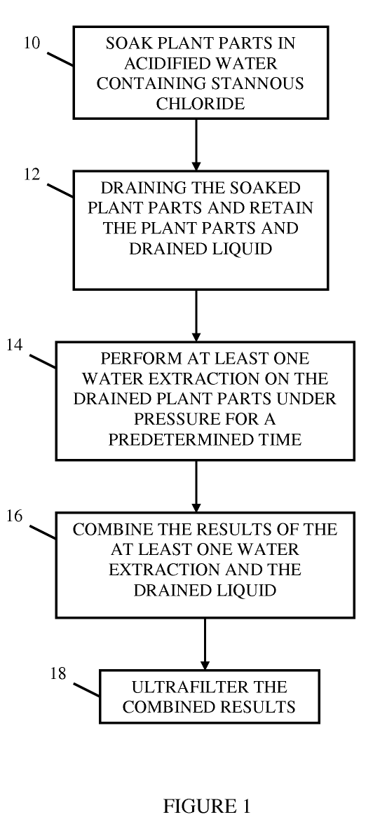

As seen in FIG. 1, the present invention may be manufactured by soaking plant parts in acidified water containing stannous chloride 10. Although fumaric acid has been used successfully, other organic and inorganic acids may be used. Citric or tartaric acid is not recommended. Next, the soaked plant parts are drained and the plant parts and drained liquid are retained 12. At least one water extraction may be performed on the drained plant parts under pressure for a predetermined time 14. The results of the one water extraction and the drained liquid are then combined 16 and the combined results are ultrafiltered 18. Preferably, the ultrafiltration is performed using a 100,000 molecular weight cutoff membrane. Filtration can be performed using any membrane material in various configurations, including spiral, flat sheet, tubular and hollow fiber. Filtration typically results in two different blue hues, with the retentate a concentrated blue and a different hue of blue in the permeate.

In a preferred embodiment of the method of making the present invention, pansy or viola extract is made by soaking the petals of the flowers with minor amounts of leaves and/or stems at ambient temperature in acidified water containing stannous chloride. After draining, the plant material is extracted with water for about 15-30 minutes in one or separate extractions, each extraction utilizing a ratio of 1:1 up to 100:1 water to plant material. Gentle pressure in the range of 10 psig to 600 psig is utilized in the final extractions. The aqueous extracts are then combined and ultimately ultrafiltered The permeate and or retentate can then be concentrated if desired. The exact chemical composition of the viola material is as yet unknown and is therefore referred to herein as simply material.

In another embodiment of the present invention, the pansy and or viola extracts are made by soaking the petals with minor amounts of leaves and or stems overnight in ethyl acetate at ambient temperature. The acetate is then gently but thoroughly drained from the plant material and chilled ethanol is added at 40 degrees F. or less. The ethanol is allowed to extract from the plant material overnight at a maximum of 40 degrees F. and then gently but thoroughly drained. The plant material is then extracted with approximately 60 degree F. water for approximately 15 minutes in three separate extractions each utilizing a ratio of 2:1 water to plant material. Gentle pressure in the range of 10 psig to 60 psig is utilized in the final three water extractions. The aqueous extracts are then combined and ultrafiltered through a 50,000 molecular weight cutoff polysulfone membrane and the permeate is concentrated either by reverse osmosis or vacuum distillation approximately 15 times. Stannous chloride is then added to the concentrate at approximately 1600 ppm.

Depending on the application and the exact hue desired, additives can be included in the dye formation. A wide variety of additives may be used and the invention is not limited to the following examples and the examples provided should be treated as representative of the types of additives that may be used in conjunction with the present invention. For example, diluents such as glycerin, propylene glycol, alcohol, sorbates, vegetable oil and corn syrup solids may be used. Emulsifiers such as polysorbates, mono-diglycerides and lecithin may be used as additives in particular formulations. Antioxidants such as rosemary herb extract may be used. Dry carriers such as maltodextrin, dextrose, vegetable fibers, silicon dioxide, dairy or soy based powders, starches, gums, polysaccharides, carboxymethylcellulose and tri-calcium phosphate may be used.

The hue of the solution may be modified by adding titanium dioxide, calcium carbonate, talc and/or pH adjusting salts. For example, the preferred pH of the present invention is 3.5. The blue flavorant may also be modified to create a natural green flavorant by the addition of a natural yellow flavorant such as turmeric, beta-carotene, or saffron.

The stabilities of these natural flavorants of the present invention at relatively low pH allow for their applicability in high acid foods and beverages as defined by the U.S. Food & Drug Administration (FDA). The natural flavorants of the present invention also have shelf lives sufficient for use in drug and cosmetic applications.

While the invention is susceptible to various modifications, and alternative forms, specific examples thereof have been herein described in detail. It should be understood, however, that the invention is not to be limited to the particular forms or methods disclosed, but to the contrary, the invention is to cover all modifications, equivalents, and alternatives falling within the spirit and scope of the appended claims.

What is claimed is:

1. A natural ingredient for food and beverages, comprising:
a plant extract; and
a metallic salt.

2. The ingredient of claim 1, wherein said plant extract comprises viola extract and said metallic salt is stannous chloride.

3. The ingredient of claim 2, wherein said viola extract comprises between about three to fifteen parts water to one part viola material.

4. The ingredient of claim 3, wherein said stannous chloride is present at between sixteen and 1600 parts per million when said ingredient has a moisture level of approximately ninety-five percent.

5. The ingredient of claim 4, wherein said stannous chloride is present at about 160 parts per million when said ingredient has a moisture level of approximately ninety-five percent.

7. The ingredient of claim 4, wherein said pH is between about 3.0 and 7.0.

8. The method of manufacturing an ingredient for food and beverages, comprising the steps of:
soaking the plant parts in a solvent containing stannous chloride;
draining the soaked plant parts and retaining the plant parts and drained solvent;
performing at least one water extraction on the drained plant parts under pressure for a predetermined time;
combining the results of the at least one water extraction and the drained solvent; and
ultrafiltering the combined results.

9. The method of claim 8, wherein the solvent comprises water and an acetate.

10. The method of claim 9, wherein the acetate comprises ethyl acetate.

11. The method of claim 8, wherein the step of performing at least one water extraction is performed under pressure in the range of 10 psig to 600 psig.

12. The method of claim 8, wherein the step of performing at least one water extraction involves the use of a ratio of between 1:1 and 100:1 water to plant parts.

13. The method of claim 8, wherein the step of ultrafiltering comprises filtering with at least a 50,000 molecular weight cutoff membrane.

14. The method of claim 13, wherein said membrane has at least a 100,000 molecular weigh cutoff.

15. The method of claim 8, wherein said stannous chloride is present at between sixteen and 1600 parts per million when the ultrafiltration permeate has a moisture level of approximately ninety-five percent.

16. The method of claim 8, further comprising the step of removing the solvent.

17. A product made by the process of claim 8.
